(19) United States
(12) Patent Application Publication
(10) Pub. No.: US 2005/0140130 A1
(43) Pub. Date: Jun. 30, 2005

(54) Vehicle steering column including a cardan joint

(76) Inventors: Andre Laisement, La Chapelle Encherie (FR); Christophe Lacaille, Coulommiers La Tour (FR)

Correspondence Address: LAWRENCE E. LAUBSCHER, SR.;LAUBSCHER LAW OFFICES, 1160 SPA ROAD, SUITE 2B, ANNAPOLIS, MD, 21403, US

(21) Appl. No.: 11/009,089

(22) Filed: Dec. 13, 2004

(30) Foreign Application Priority Data
Dec. 16, 2003 (FR) 0314846

(51) Int. Cl. B62D 1/18

(52) U.S. Cl. 280/775

(57) ABSTRACT

A cardan joint adapted for use in a vehicle steering column includes a tubular connecting member mounted concentrically about a steering shaft, and a first tubular yoke member having a first end mounted concentrically on one end of the connecting member, the other end of the yoke member having a pair of arm portions that extend parallel with and on opposite sides of the longitudinal axis of the shaft, the arms containing aligned openings that define a pivot axis extending normal to the shaft axis, characterized by the provision of a first positioning arrangement that controls the rotational orientation of the yoke member relative to the connecting member, and a second positioning arrangement that controls the axial position of the yoke member relative to the connecting member. A locking arrangement serves to lock the other end of the connecting member to the steering shaft, and a third positioning arrangement serves to rotationally orient the connecting member relative to the shaft.

### BACKGROUND OF THE INVENTION

1. Field of the Invention

This invention relates to a cardan joint for use in a vehicle steering column, including a first tubular yoke member, and a tubular connecting member mounted concentrically between the yoke member and the steering shaft of the column, characterized by the provision of first positioning means for rotationally orienting the yoke member relative to the connecting member, second positioning means for limiting the axial displacement of the yoke member relative to the connecting member, and third positioning means for rotationally orienting the connecting member relative to the steering shaft.

2. Description of the Related Art

Currently, the steering column of an automotive vehicle comprises two portions: a top portion, which is connected to the steering wheel, and a middle portion, which is connected to the gearbox that controls a steering rod for the steering wheels. The top portion and the middle portion are connected with each other by a homokinetic joint, called a cardan joint. This cardan joint includes a crossbar pivot member arranged between two yoke members one of which is connected with the top portion, while the other one is connected with the middle portion.

The yoke members of these known cardan joints normally consist of a single unitary monoblock element. Consequently, the means for locking the yoke member of the joint upon the corresponding steering transmission shaft has an axis with an orientation that is determined with respect to the axis of the cardan joint.

On modern vehicles, the engine compartment is very crowded, and the limited accessibility causes tightening of the clamp upon the steering transmission shaft to be a very delicate operation. This means that one must design a specific yoke member for each type of vehicle, thereby resulting in a higher production cost.

The present invention was developed to provide an improved cardan joint especially suitable for use in the steering column of an automotive vehicle, which will avoid the aforementioned drawbacks of the known devices, and which is suitable for use with all types of vehicles.

### BRIEF SUMMARY OF THE INVENTION

According to a primary object of the invention, a cardan joint is provided for use in the steering column assembly of an automotive vehicle, characterized by the provision of a first tubular yoke member that is mounted concentrically on a tubular connecting member that in turn is mounted concentrically on the steering transmission shaft of the column, first and second positioning means being provided for rotationally and axially orienting the yoke member relative to the connecting member, respectively. Third positioning means may be provided for rotationally orienting the connecting member relative to the steering shaft.

According to a more specific object of the invention, the cardan joint includes a pivot pin that extends between two parallel arms of the yoke member, and a fastening bolt member operable to tightly fasten the connecting member to the steering transmission shaft. It includes a yoke member having a cylindrical end from which extend a pair of parallel spaced arm portions carrying the pivot axis, and a concentrically arranged connecting member that connects the yoke member to the steering shaft, the yoke member and connecting member having an axis that is common with the axis of the steering shaft. The connecting member is bifurcated at one end that is provided with a screw threaded fastening member that is operable to draw the bifurcated end portion of the connecting member into tight engagement with the outer peripheral surface of the steering shaft. The outer face of the connecting member and the inner face of the yoke member have conjugate shapes so as to bring about the desired rotational orientation between the cardan joint yoke member and the connecting element, thereby to obtain angular positioning means and rotational connection means for the connecting element with respect to the joint fork. Axial positioning means are provided between the connecting element and the joint yoke member.

To make sure that the cardan clamp consists of one and the same assembly, the conjugate shapes of the outer face and the inner face are dimensioned so as to obtain a certain tightening between the cylindrical portion and the cylindrical end and thus to obtain the means for axial connection between the connecting element and the joint yoke member.

According to another embodiment of the invention, the conjugate shapes of the outer face and of the inner face consist of grooves. According to another embodiment of the invention, the conjugate shapes of the outer face and of the inner face consist of shape saw tooth-like indentations.

The system for locking the cardan clamp used in the invention consists of the fact that the connecting element has a locking portion that comprises a cylindrical element with two locking elements. The two locking elements are separated by an axial cover that leads into an inner face of the cylindrical element, while the locking pin is essentially normal to said axial opening. Moreover, a transversal radially-inwardly directed tangential slot is provided on the cylindrical portion adjacent the locking elements. Finally, the locking means consist of a locking screw.

According to the invention, the connecting element has inner faces which have shapes that are conjugate with the steering transmission shaft so as to ensure the desired rotational orientation connection. Preferably, the conjugate shapes of the inner faces of the connecting element and the transmission shaft consist of grooves.

According to an embodiment of the invention, the cardan joint has a connecting element which consists of a forged and machined piece. According to another embodiment of the invention, the connecting element consists of a piece that is made of machined, shaped sheet metal. According to another embodiment of the invention, the connecting element consists of a cut and machined drawn piece.

The cardan joint according to the invention thus offers the advantage of presenting an assembly that is made from a joint yoke member which can be standard, with a connecting element that can also be standard. This permits large-series production with a lower cost. Moreover, a decisive advantage of the invention resides in the fact that it permits an orientation of the connecting element with respect to the joint yoke member so that the cardan joint will be adapted for use with each type of vehicle with more accessible and thus easier assembly.

### BRIEF DESCRIPTION OF THE DRAWINGS

Other objects and advantages of the invention will become apparent from a study of the following specification when viewed in the light of the accompanying drawings, in which:

FIG. 1 is a side perspective view of one yoke member and connecting member assembly, and

FIG. 2 is a rear perspective view of the connecting member of FIG. 1;

FIG. 3 is a side perspective view of a second embodiment of the yoke member and connecting member assembly, and

FIG. 4 is a front perspective view of the connecting member of FIG. 3;

FIG. 5 is a sectional view of the connecting member of FIG. 1, and

FIG. 6 is a detailed view taken along the line 6-6 of FIG. 5;

FIG. 5A is a sectional view taken along the line 5A-5A of FIG. 1;

FIG. 7 is a detailed sectional view taken along the line 7-7 of FIG. 5A; and

FIG. 7A is modification of the rotational orienting means of FIG. 7.

### DETAILED DESCRIPTION OF THE INVENTION

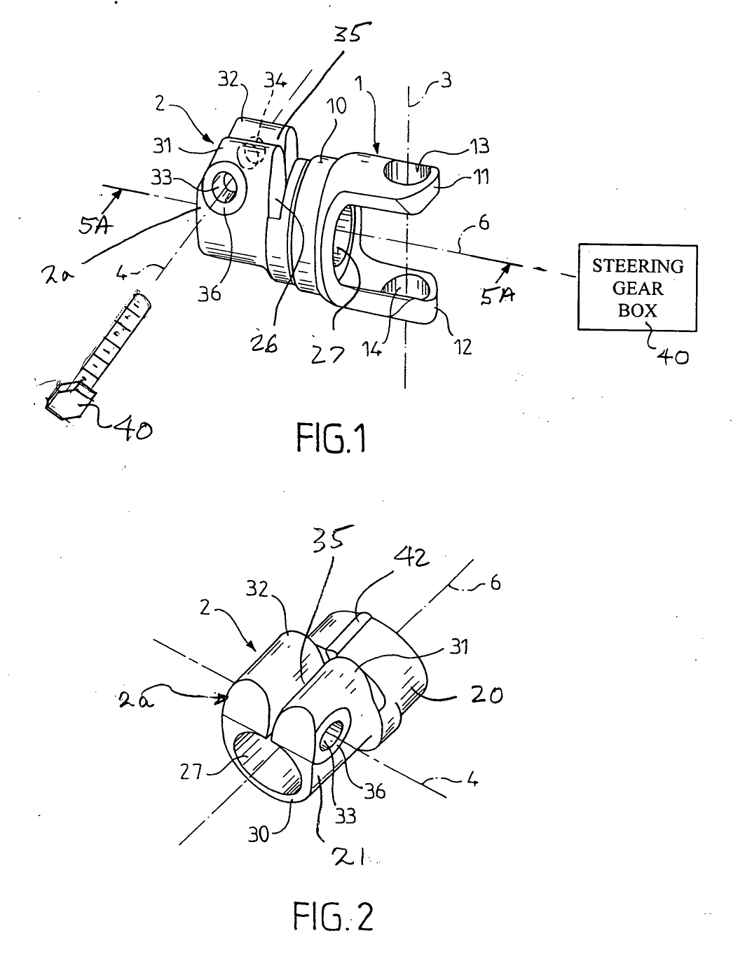

Referring more particularly to FIGS. 1 and 2, the cardan joint of the present invention includes a first yoke or fork member 1 that is connected with the steering shaft 5 by means of a connecting member 2. As shown in FIG. 2, the tubular connecting member 2 contains a through bore 27 that extends from a tubular first end portion 20 through a bifurcated second end portion 21. The connecting member 2 is provided at its second end portion 21 an enlarged locking portion 2a that contains a longitudinal axially extending slot 35 that divides the enlarged portion into a pair of locking portions 31 and 32. A pair of aligned openings 33 and 34 having a common transverse locking axis 4 are provided in the locking portions 31 and 32, respectively, thereby to define the locking axis 4 that extends transversely of the longitudinal axis 6 of the steering shaft 5. The bifurcated portion 21 of the connecting element 2 is arranged for locking engagement with the external surface of the steering shaft 5 by means of a threaded bolt member 40 that extends through the oversized opening 33 contained in locking portion 31, and into threaded engagement with the corresponding bore 34 contained in the locking portion 32.

Thus, upon tightening of the bolt 40 with the head portion thereof in engagement with the supporting face 36 of the oversized opening 33, the threaded portion of the bolt engages the threaded opening 34 to draw the locking portions 31 and 32 together into tight locking engagement with the outer surface 22 of the shaft 5, as shown in FIG. 5A.

The tubular first end portion 20 of the connecting element 2 extends within a corresponding bore 15 (FIG. 5A) that is contained in one end of the tubular portion 10 of the joint yoke member 1. At its other end, the yoke member 1 is provided with a pair of arm portions 11 and 12 that extend parallel with and on opposite sides of the longitudinal axis 6 of the steering shaft 5. These arm portions 11 and 12 contained aligned openings 13 and 14 that are arranged parallel with and on opposite sides of the longitudinal axis 6 of the steering shaft 5, which openings define a pivot axis 3 that extends normal to the longitudinal axis 6 of the steering shaft 5. Connected with this pivot axis 3 is a second yoke member (not shown) that is rotated about its longitudinal axis through 90 degrees relative to the first fork member one. As is known in the art, pivot pin means (not shown) having an axis 3 extend through the openings 13 and 14 to connect the second yoke member (not shown) with the illustrated first yoke member, and with the steering gear box 42 of the vehicle steering system.

In accordance with a characterizing feature of the present invention, first positioning means are provided for rotationally orienting the cardan joint yoke member 1 with the connecting member 2 relative to the longitudinal axis 6 of the steering shaft 5. To this end, the outer surface 22 of the tubular first end portion 20 of the connecting member 2 is provided with a plurality of circumferentially spaced, longitudinally-extending rib portions or protrusions 23 that extend within corresponding grooves 17 contained in the inner peripheral surface 15 of the yoke member 1. In the embodiment of FIG. 7, the profiles of the ribs or protrusions 23 and the groove 17 are smooth, while in the modified embodiment of FIG. 7A, the protrusions 24 and the recesses 18 have a sharp pointed saw tooth configuration.

Referring to FIGS. 5 and 5a, it will be seen that the connecting member contains adjacent the enlarged portion 21a a radially inwardly directed slot 26 that provides a certain degree of flexibility to the bifurcated enlarged portion 21a. An annular rib provided on the outer face 22 of the first end portion 20 of the connecting member 2 defines an annular end face 25 that is arranged for engagement by a corresponding end face 16 of the tubular portion of the yoke member 1, thereby to limit the axial displacement of the yoke member 1 relative to the connecting member 2.

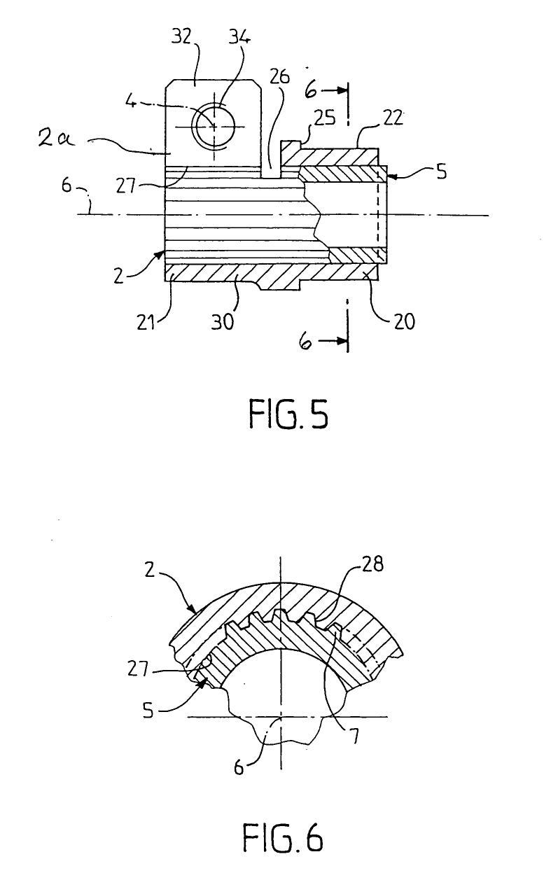

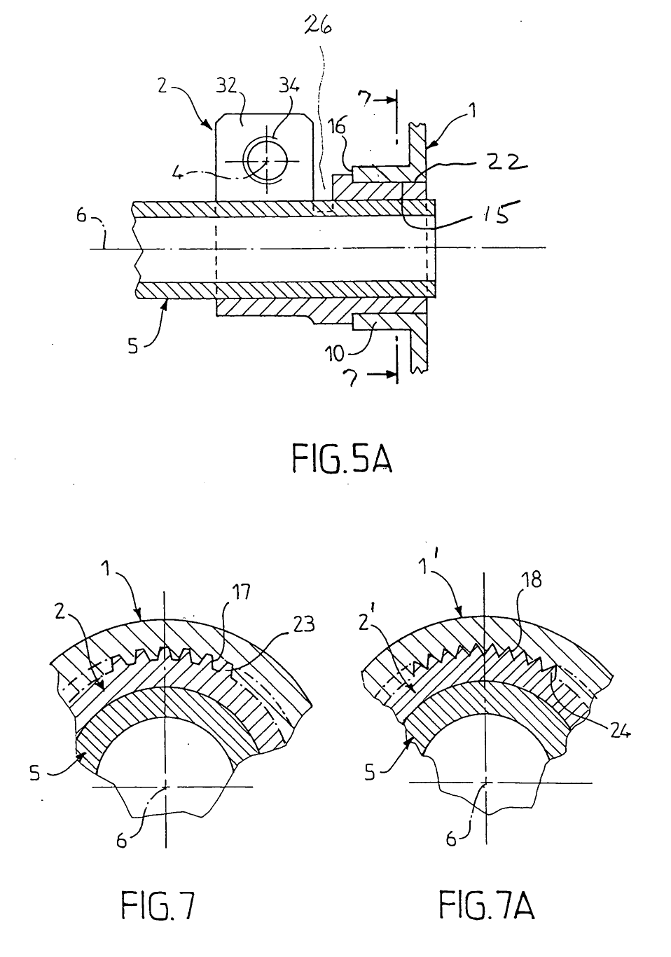

Referring now to FIG. 6, in accordance with another characterizing feature of the invention, third positioning means are provided for rotationally orienting the connecting member 2 relative to the steering shaft 5. To this end, a plurality of circumferentially spaced longitudinally extending ribs or protrusions 7 are provided on the outer surface of the steering shaft 5 for engagement with corresponding grooves 28 is contained on the inner peripheral surface of the through bore 26 of the connecting member 2. Thus, owing to the relationship of the first positioning means 17 and 23 of FIG. 7 (and 18 and 24 of FIG. 7A), together with the third positioning means 7 and 28 of FIG. 6, the pivot axis 3 is always maintained that a desired orientation relative to the longitudinal axis 6 of the steering shaft 5.

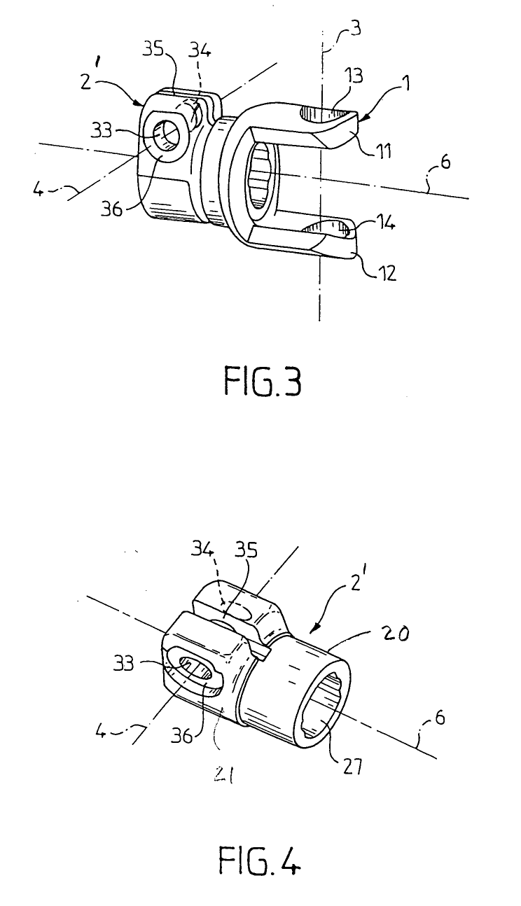

In the embodiment of FIGS. 1 and 2, the connecting element 2 is formed from a single sheet metal piece that is bifurcated at each end, the bifurcated portions at the first tubular end being welded together by a weld seam 42. In the embodiment of FIGS. 3 and 4, the connecting member 2′ is formed as a single unitary casted and machined component. If desired, the connecting member could also be formed from a machine drawn piece.

As indicated above, the cooperation between the end face 16 of the fork member 1 with the support face 25 on the outer face 22 of the connecting member 2 limits the axial displacement of the fork member relative to the connecting member, thereby to further accurately position the pivot axis 3 relative to the longitudinal axis 6 of the steering shaft 5.

While in accordance with the provisions of the Patent Statutes the preferred forms and embodiments of the invention have been illustrated and described, it will be apparent to those skilled in the art that various changes may be made without deviating from the inventive concepts set forth above.

1. A cardan joint adapted for connection with the steering shaft of a vehicle steering system, comprising:
(a) a steering shaft (5) having a longitudinal axis (6); and
(b) a cardan joint including a first yoke member (1) having:
(1) a tubular body portion (10) containing a first through bore (15) having an axis collinear with the shaft longitudinal axis; and
(2) a fork portion integral with one end of said tubular body portion, said fork portion including a pair of parallel spaced arm portions (11;12) extending parallel with and on opposite sides of said steering shaft longitudinal axis, said arms containing aligned openings (13;14) defining a pivot axis (3) extending normal to said steering shaft longitudinal axis;
(c) a tubular connecting member (2) mounted concentrically about said steering shaft, said connecting member including:
(1) a first end portion (20) extending concentrically within said first yoke member;
(2) a second end portion (21) remote from said first yoke portion, said second end portion including locking means (4) for locking said connecting member with said steering shaft;
(d) first positioning means for rotationally orienting said yoke member relative to said connecting member, said first positioning means including a pair of conjugate surfaces (15, 22) arranged concentrically between said connecting member first end portion and said yoke member tubular end portion; and
(e) second positioning means (16, 25) for effecting a desired axial position of said yoke member relative to said connecting member.

2. A cardan joint as defined in claim 1, wherein said second positioning means at least partly includes said first positioning means.

3. A cardan joint as defined in claim 1, wherein said first positioning means comprises a plurality of circumferentially spaced longitudinally extending smooth protrusions (23) arranged on the outer periphery of said connecting member one end for engagement with corresponding smooth valleys (17) contained on the inner surface of said yoke member first through bore.

4. A cardan joint as defined in claim 1, wherein said first positioning means includes a plurality of circumferentially spaced longitudinally-extending pointed teeth (24) arranged on the outer periphery of said connecting member one end for engagement with corresponding pointed teeth (18) provided on the inner periphery of said yoke member first through bore.

5. A cardan joint as defined in claim 1, wherein said locking means comprises a radially outwardly extending enlarged portion on said connecting member second portion, said enlarged portion containing a longitudinal slot (35) defining a pair of locking portions (21a, 21b), and means for displacing said locking portions together, thereby to effect locking engagement of said connecting member with said shaft.

6. A cardan joint as defined in claim 5, wherein the outer surface of said connecting member second portion contains a radially inwardly extending slot (26) adjacent said enlarged portion, thereby to provide sufficient flexibility to permit displacement of said locking portions toward each other.

7. A cardan joint as defined in claim 5, wherein said locking portions contain aligned openings (33, 34) defining a transversely extending locking axis (4); and further wherein said locking means includes a threaded member (40) that extends collinearly with said locking axis through one of said openings into threaded engagement with the other of said openings.

8. A cardan joint as defined in claim 1, and further including:
(f) third positioning means for rotationally orienting said connecting member relative to said steering shaft.

9. A cardan joint as defined in claim 8, wherein said third positioning means includes a plurality of circumferentially spaced longitudinally extending ribs (7) provided on the outer periphery of said shaft for engagement with corresponding grooves (28) contained on the inner periphery of said connector member.

10. A cardan joint as defined in claim 1, wherein said connecting member is a unity member formed by casting.

11. A cardan joint as defined in claim 1, wherein said connecting member is formed by shaping a metal sheet.

12. A cardan joint as defined in claim 1, wherein said connecting member is formed by cutting and machining a unitary piece.
